(19) United States
(12) Patent Application Publication
(10) Pub. No.: US 2025/0215176 A1
(43) Pub. Date: Jul. 3, 2025

(54) ORGANOPOLYSILOXANE FOAM WITH CERAMIC MICROSPHERES

(71) Applicants: Dow Silicones Corporation, Midland, MI (US); Dow Global Technologies LLC, Midland, MI (US)

(72) Inventors: Chi-Hao Chang, Midland, MI (US); Craig F. Gorin, Midland, MI (US); Bizhong Zhu, Midland, MI (US); Michael Whitbrodt, Bay City, MI (US); Xiangyang Tai, Shanghai (CN); Minbiao Hu, Shanghai (CN); Xuesi Yao

(21) Appl. No.: 18/852,273

(22) PCT Filed: May 9, 2022
(86) PCT No.: PCT/CN2022/091786

§ 371 Date: Sep. 27, 2024

(51) Int. Cl. C08J 9/00; C08K 3/22; C08K 7/24

(52) U.S. Cl. CPC C08J 9/0066; C08K 3/22; C08K 7/24; C08J 2205/06; C08J 2383/05; C08J 2383/07; C08K 2003/2227; C08K 2201/005

(57) ABSTRACT

An insulating, compressible, and flame-resistant foamed material comprises a polyorganosiloxane foam, a fire retardant, and micron-sized hollow ceramic particles. The foamed material is useful for providing heat insulation, flame resistance, and compressibility for applications such as lithium-ion batteries.

### BACKGROUND OF THE INVENTION

The present invention relates to an organopolysiloxane foam containing micron-sized ceramic particles.

Rechargeable batteries such as lithium-ion batteries (LiBs) are commonly used in a variety of applications including electric vehicles (EVs) and grid energy storage systems. Although LiBs have the desirable properties of high energy density and stability, safety concerns currently limit their usefulness. First, failure of an LiB cell can be triggered due to a manufacturing defect, an internal short circuit, overheating, overcharging, or mechanical impact; second, the heat generated from the failing cell may propagate, thereby causing a thermal runaway in adjacent cells. The rapid pressure build-up arising from these thermal events increases the risks of fire and explosion.

Thermal runaway can be mitigated by placing a thermal barrier between cells in an LiB module, which provide heat insulation and flame resistance. Commonly used thermal barriers such as aerogel, ceramic fiber, and mica board provide such properties; however, aerogel and ceramic fiber suffer poor mechanical resilience, while mica board suffers from poor compressibility. On the other hand, although silicone blown foam provides adequate compressibility and, therefore, suitable for batteries of low and moderate energy density, it suffers from insufficient heat insulation to prevent thermal runaway for the very high energy density battery packs. Accordingly, it would be desirable in the field of thermal barriers for rechargeable batteries to create a barrier that provides heat insulation, flame resistance, and satisfactory compressibility.

### SUMMARY OF THE INVENTION

The present invention addresses a need in the art by providing an insulating, compressible, and flame-resistant foamed material comprising, based on the weight of the foamed material, from 35 to 95 weight percent of a polyorganosiloxane foam; from 1 to 30 weight percent of a fire retardant; and from 1 to 35 weight percent of hollow ceramic particles having a volume mean particle size in the range of from 25 μm to 300 μm; wherein the foamed material has a density in the range of from 0.10 to 0.90 g/cm³. The foamed material of the present invention is useful in providing one or more spacers in a lithium-ion battery that is heat insulating, flame resistant, and compressible.

### DETAILED DESCRIPTION OF THE INVENTION

The present invention is an insulating, compressible, and flame-resistant foamed material comprising, based on the volume of the article, from 35 to 95 weight percent of a polyorganosiloxane foam; from 1 to 30 weight percent of a fire retardant; and from 1 to 35 weight percent of hollow ceramic particles having a volume mean particle size in the range of from 25 μm to 300 μm; wherein the foamed material has a density in the range of from 0.10 to 0.90 g/cm³.

The polyorganosiloxane foamed material of the present invention can be prepared by modification of a method such as described in U.S. Pat. No. 5,358,975. For example, a polydimethylsiloxane functionalized with at least two, and preferably at least three Si—H groups (a) is advantageously contacted with one or more hydroxyl containing compounds which is water, an alcohol, diol, polyol, or a compound containing at least one silanol group (b), a divinyl-functionalized polydimethylsiloxane (c), a hydrosilylation catalyst such as a platinum-based catalyst (d), a fire retardant (e), and hollow ceramic particles (f) to form a crosslinked network of an insulating, compressible, and flame-resistant foamed material with —Si—CH₂—CH₂—Si— groups and —Si—O—R groups, where R is H or a the structural unit (i.e., the reaction product) of the alcohol, the diol, the polyol, or the silanol. The total of components (a), (b), and (c) range from 35 or from 40 weight percent, to 80 or to 70 weight percent of the polyorganosiloxane foam.

It may be advantageous to prepare the foamed material using a 2-part approach wherein in a first vessel a first portion of the divinyl-functionalized polydimethylsiloxane; a first portion of the fire retardant; the hydrosilylation catalyst; the hydroxyl containing compound or compounds; and a first portion of the hollow ceramic particles are blended to form a Part A composition. In a second vessel, the remaining portion of the divinyl-functionalized polydimethylsiloxane; a polymer resin blend, which is a mixture of a divinyl-functionalized polydimethylsiloxane and a crosslinked organopolysiloxane resin; the remaining portion of the fire retardant; the polydimethylsiloxane functionalized with at least three Si—H groups; and the remaining portion of the hollow ceramic particles are blended to form a Part B composition. Parts A and B are then combined and mixed, then poured between two release film sheets to form the foamed material of the present invention.

The fire retardant is a metal hydroxide, carbonate, hydroxide-carbonate, or hydrate that, upon heating, releases CO₂ or water or both. Examples of fire retardants include Al(OH)₃, Mg(OH)₂, Ca(OH)₂ MgCO₃·3H₂O (nesquehonite), Mgs(CO₃)₄(OH)₂·4H₂O (hydromagnesite), MgCa(CO₃)₂ (huntite), AlO(OH) (boemite), NaHCO₃, and hydrated MgSO₄ (epsomite). The polyorganosiloxane foamed material comprises from 1 or from 2 or from 3 weight percent, to 30 or to 20 or to 15 weight percent of the fire retardant, based on the weight of the foamed material.

The composition further comprises from 1 or from 5 or from 10 weight percent to 35 or to 30 to 25 weight percent of hollow, air-filled or inert gas-filled ceramic particles. As used herein “ceramic” refers to crystalline or semi-crystalline inorganic oxides, nitrides, carbides, oxynitrides, or oxycarbides of metals such as aluminum (e.g., crystalline or semi-crystalline Al₂O₃), silicon (e.g., crystalline or semi-crystalline SiO₂), or calcium (e.g. crystalline or semi-crystalline CaO), or combinations thereof. The degree of crystallinity can be measured by X-ray powder diffraction. As used herein, the term “semi-crystalline” refers to a ceramic material with amorphous and crystalline regions. The hollow ceramic particles have a mean volume particle size of from 25 μm or from 50 μm or from 70 μm, to 300 μm or to 200 μm or to 150 μm as measured using a dynamic light scattering analyzer such as a Beckman Coulter LS 130 Particle Size Analyzer. The resultant article has a density in the range of from 0.10 or from 0.15 g/cm³, to 0.90 or to 0.50 g/cm³.

In another aspect, the present invention is a composition comprising, based on the weight of the composition, a) from 2 to 50 weight percent of a polysiloxane functionalized with at least two Si—H groups and having a degree of polymerization in the range of from 5 to 1000; b) from 1 to weight 50 percent of water, an alcohol, a diol, a polyol, or a compound containing one or more silanol groups; c) from 10 to 90 weight percent of a polysiloxane functionalized with at least one ethylenically unsaturated group and having a degree of polymerization in the range of from 20 to 2000; wherein the total concentration of components a, b, and c is in the range of from 35 to 95 weight percent, based on the weight of the composition; d) a catalytic amount of a hydrosilylation catalyst; e) from 1 to 30 weight percent of a fire retardant; and f) from 1 to 35 weight percent of hollow ceramic particles having a volume mean particle size in the range of from 25 μm to 300 μm.

In yet another aspect, the present invention is a battery module comprising a shell containing an array of spatially separated battery cells and polyorganosiloxane foam material contacting adjacent battery cells. The polyorganosiloxane foam may contact battery cells by filling the spaces between adjacent battery cells with the foam and/or by covering the batter cells with the foam. The battery module may further comprise end plates at the internal edges of the shell that are in direct or indirect contact with battery cells nearest the edges. The foam material can be inserted into cavities between adjacent battery cells and between the cells and end plates; alternatively, the foam precursor can be applied onto the cells and into the cavities, then cured to form the foamed material.

The foamed material of the present invention has been found to provide the desired properties of heat insulation, flame resistance, and compressibility in LiB thermal barrier applications.

In the following examples, M_{w} and Mₙ of the ViMe₂SiO_{1/2}/(CH₃)₃Si—O_{1/2}/SiO_{4/2} resin was determined by gel permeation chromatography using a gpc column packed with 5-mm diameter sized divinyl benzene crosslinked polystyrene beads pore type Mixed-C (Polymer Laboratory). THF was used as the mobile phase and detection was carried out by a refractive index detector.

### Example 1—Preparation of Foamed Organopolysiloxane Article with Ceramic Particles

A first component (Part A) was prepared by mixing together, using a Flacktek Speed Mixer, a dimethylvinylsiloxy end-capped polydimethylsiloxane having a viscosity of ˜40,000 mPas (Polymer 1, 11.3 pbw), a 64:36 w/w blend of 1) a dimethylvinylsiloxy-terminated polydimethylsiloxane, having a viscosity of ˜1,900 mPa·s, and ˜0.22 wt. % of Vi; and 2) a ViMe₂SiO_{1/2}/(CH₃)₃Si—O_{1/2}/SiO_{4/2} resin, having a ViMe₂SiO_{1/2}:(CH₃)₃Si—O_{1/2}:SiO_{4/2} structural unit ratio of 5:40:55, a Mₙ of 5000 and a M_{w} of 21,400 (Polymer-Resin Blend, 64.9 pbw); and Micral 855 aluminum hydroxide (15.2 pbw). The contents were stirred at 2000 rpm for 30 s, after which time, a complex of Pt(0) and divinyltetramethyldisiloxane (0.93 pbw, 0.62 wt % Pt), 1,4-butanediol (2.6 pbw), and benzyl alcohol (3.3 pbw) were added to the mixture and the contents were stirred at 2000 rpm for 30 s. Finally, Elminas Spheres HCMS-W150 Hollow Ceramic Particles (mean volume particle size of 100 μm; 20 pbw) were added to the mixture and the contents were stirred at 2000 rpm for 30 s.

A second composition (Part B) was similarly prepared by mixing together Polymer 1 (8.9 pbw), Polymer Resin Blend (51 pbw), and Hymod M855 aluminum hydroxide (26.4 pbw). The contents were stirred at 2000 rpm for 30 s, after which time a linear organohydrogenpolysiloxane having a viscosity of 30 mPa·s and 1.6 wt % SiH content (6.7 pbw), and a polydimethylorganohydrogensiloxane with viscosity of 5 mPa·s and 0.7 wt % SiH content (5.1 pbw) were added to the mixture and the contents were stirred at 2000 rpm for 30 s. Then, Elminas Spherers HCMS-W150 Hollow Ceramic Particles (20 pbw) were added to the mixture and the contents were stirred at 2000 rpm for 30 s.

Equal amounts of Parts A and B were then mixed, and the mixture was poured between two release film sheets (matte mylar film). The initial (before foaming) thickness was controlled at 0.045 inch using a nip roller. The sample was cured at 70° C. for 5 min, then 100° C. for 15 min, producing a foam sheet that was used for further testing. (Density=0.31 g/cm³)

### Example 2—Preparation of Foamed Organopolysiloxane Article with Ceramic Particles

The process for preparing the foamed article of Example 1 was carried out in substantially the same way except that Elminas Spheres HCMS THERMO-W75 Hollow Ceramic Particles (mean volume particle size of 80 μm, 20 pbw) were used in Parts A and B. (Density=0.31 g/cm³)\

### Example 3—Preparation of Foamed Organopolysiloxane Article with Ceramic Particles

The process for preparing the foamed article of Example 1 was carried out in substantially the same way except that Elminas Spheres HCMS-W300 Hollow Ceramic Particles (mean volume particle size of 180 μm, 20 pbw) were used in Parts A and B. (Density=0.34 g/cm³)

### Thermal Insulation and Flammability

The foams prepared as described in the examples were tested for thermal insulation and flammability using a hot plate set onto a hydraulic press. The hot plate was set at 600° C. with an insulator on the top of surface. Four thermocouples (K-type) were fixed onto an aluminum heat sink (4″×4″×0.47″) using Kapton tape. A sample (4″×4″) was then placed and fixed onto the heat sink using Kapton tape. An additional thermocouple (K-type) was attached to the sample surface using Kapton tape. The insulator was removed from the hot surface and the sample attached to the heat sink was rapidly placed onto the hot surface with the sample surface facing the hot plate surface, and the Al heat sink facing the opposite side. The pressure was quickly increased to 355 kPa. The interfacial temperature between the hot plate surface and the sample surface, and the interfacial temperature between the sample surface and the heat sink were recorded using a data logger. Once the time reached 300 s, the pressure was released, and the test was ended. A temperature at the sample surface of <300° C. was considered acceptable. No observable flame throughout the test is considered acceptable flame resistance.

### Hardness

Hardness was measured using a Shore 00 durometer. A test specimen was placed on a hard flat surface. The indenter of Shore 00 durometer was then pressed onto the specimen making sure that it was parallel to the surface. The hardness was read during firm contact with the specimen. A hardness of <80 was considered acceptable.

### Compression Force

Compression force was measured using a TA.HDplus texture analyzer equipped with a 100 kg load cell, an aluminum probe with a diameter of 40 mm, and a flat heavy-duty aluminum substrate. A silicone foam sample was cut in a circle using a die cut with a diameter of 1″ and placed between the substrate and the probe. The probe was initially set at the same height as the sample thickness, and lowered at the rate of 1 mm/s until the pressure maxed out. The sample thickness and pressure were recorded as a compression force curve. The pressures at 30% of original sample thickness were recorded. A compression force of <500 kPa was considered acceptable.

### Foam Density

Foam density was calculated based on the average thickness and weight of two foam samples with a diameter of 1 inch.

The properties of the ceramic filled organopolysiloxane article were compared to a commercial organopolysiloxane article (COHRlastic Silicone Foam, available from Stockwell Elastomerics), which was similar in construction to the example foams except it did not contain hollow ceramic particles.

Table 1 is a summary of performance properties for the foams of the Examples 1-3 and the commercial comparative foam. Density was measured in g/cm³; Hardness was measured in Shore 00 units; Compressive Force (Force) was measured in kPa@30% compression; Temperature at 600° C. (T after 300 s) refers to the sample surface temperature after 300 s; and Flammability refers to observability of a flame during the thermal insulation test.

TABLE 1
Properties of Organopolysiloxane Article

| | | Com- | Exam- | Exam- | Exam- |
|---|---|---|---|---|---|
| Property | Criteria | parative | ple 1 | ple 2 | ple 3 |
| Density | <0.9 | 0.23 | 0.31 | 0.31 | 0.34 |
| Hardness | <80 | 35 | 65 | 69 | 71 |
| Force | <500 | 17 | 246 | 306 | 300 |
| T after 300 s | <300° C. | 334° C. | 246° C. | 255° C. | 294° C. |
| Flammability | No Flame | No Flame | No Flame | No Flame | No flame |

Table 1 illustrates that the foams of the present invention pass all tests, while the commercial example fails the thermal insulation test. It has been surprisingly discovered that hollow ceramic particles decrease the surface temperature at 300 s without adversely impacting other critical properties of the foam. It has further been discovered that hollow ceramic particle sizes in the range of from 50 μm to 150 μm were especially effective in decreasing surface temperature.

1. An insulating, compressible, and flame resistant foamed material comprising, based on the volume of the foamed material, from 35 to 95 weight percent of a polyorganosiloxane foam; from 1 to 30 weight percent of a fire retardant; and from 1 to 35 weight percent of hollow ceramic particles having a volume mean particle size in the range of from 25 μm to 300 μm; wherein the foamed material has a density in the range of from 0.10 to 0.90 g/cm³.

2. The foamed material of claim 1 wherein the foamed material comprises from 50 to 80 weight percent of the polyorganosiloxane foam, and from 2 to 20 weight percent of the fire retardant.

3. The foamed material of claim 2 wherein the fire retardant is Al(OH)₃, Mg(OH)₂, MgCO₃·3H₂O, or Mg₅(CO₃)₄(OH)₂·4H₂O, MgCa(CO₃)₂, AlO(OH), NaHCO₃, or hydrated MgSO₄, or a combination thereof.

4. The foamed material of claim 1 which has a density in the range of from 0.15 to 0.50 g/cm³.

5. The foamed material of claim 3 which has a density in the range of from 0.15 to 0.50 g/cm³, wherein the hollow ceramic particles have a mean volume particle size by dynamic light scattering in the range of from 25 μm to 200 μm.

6. The foamed material of claim 5 wherein the hollow ceramic particles have a mean volume particle size by dynamic light scattering in the range of from 50 μm to 150 μm.

7. The foamed material of claim 6 wherein the hollow ceramic particles are crystalline or semi-crystalline Al₂O₃ particles, crystalline or semi-crystalline SiO₂ particles, or crystalline or semi-crystalline CaO particles, or a crystalline or semi-crystalline Al/Mg/Ca silicate.
